(19) United States
(12) Patent Application Publication
(10) Pub. No.: US 2012/0304713 A1
(43) Pub. Date: Dec. 6, 2012

(54) OPTICAL DEVICE

(76) Inventors: Ta-Yi CHIEN, Taipei City (TW); Hai-Yin Hsu, Taipei City (TW); Kuan-Pei Chen, Taipei City (TW); Fen-Ling Hu, Taipei City (TW); Kuan-Yu Chen, Taipei City (TW); Wei-Yu Lee, Taipei City (TW); Kun-Yi Lee, Taipei City (TW); Yen-Juei Lin, Taipei City (TW)

(21) Appl. No.: 13/484,510

(22) Filed: May 31, 2012

(30) Foreign Application Priority Data
Jun. 3, 2011 (TW) 100119632

(51) Int. Cl. E05B 47/02; E05B 35/00

(52) U.S. Cl. 70/276; 70/279.1

(57) ABSTRACT

An optical device includes: a lock having a locking unit and an operation unit having at least a sensor; and a key configured to correspond to the lock. The key includes an unlocking unit having at least a light-guiding element for transmitting light between the operation unit and the unlocking unit. The operation unit is activated to unlock the locking unit after the sensor detects and recognizes the transmitted light. After encoding, the optical device of the present invention cannot be reproduced and the encoded light beam will not be intercepted and decoded easily so as to satisfy our security demands. Further, the structure of the optical device of the present invention does not decay easily. Therefore, the present invention has an excellent anti-theft effect and a reduced production cost.

### BACKGROUND OF THE INVENTION

a) Field of the Invention

The present invention relates to an optical device, in particular to a set of a key and a lock with optical designs, whereby light can be transmitted between the lock and the key. The encoded light will not be intercepted and decoded easily. After encoding, the optical device of the present invention cannot be reproduced so as to satisfy our security demands. Further, the structure of the optical device of the present invention would not decay easily. Therefore, the present invention has an excellent anti-theft effect and a reduced production cost.

b) Description of the Prior Art

Traditionally, a lock comprises a lock body, a lock core assembled in the lock body, and a lock bolt drivingly connected to the lock core. In order to unlock this lock, an associated key is prepared by forming a plurality of grooves having different depth on its surfaces. When a user intends to unlock the lock, the user has to insert the associated key into a key slot and turns the associated key, so that the lock core inwardly presses the lock bolt to unlock the lock.

However, since the conventional lock and key are made of metallic materials and the above-mentioned mechanical parts are drivingly connected with each other in the lock, it is uneasy to assemble these components together in the lock and causes the cost of the lock raise. Further, the key usually has a flat shape, and the mechanically driving connection between the key and the lock core is well-known so that a conventional key will be reproduced easily. Thus, the lock will be unlocked or damaged by others in minutes. As a result, the anti-theft effect of the conventional lock and key is insufficient.

### SUMMARY OF THE INVENTION

In order to solve the above problems, an objective of the present invention is to provide an optical device, whereby light can be transmitted between the lock and the key and the encoded light will not be intercepted and decoded easily. After encoding, the optical device of the present invention cannot be reproduced. Further, the structure of the optical device of the present invention does not decay easily. Therefore, the present invention has an excellent anti-theft effect and a reduced production cost.

In order to achieve the above objective, the present invention is to provide an optical device, including: a lock comprising at least a locking unit and at least an operation unit having at least a sensor; and a key configured to correspond to the lock, the key comprising at least an unlocking unit having at least a light-guiding element for transmitting light between the operation unit and the unlocking unit, wherein the operation unit is activated to unlock the locking unit after the sensor detects and recognizes the encoded light.

In a preferred embodiment of the present invention, the locking unit can be a mechanical lock or an electromagnetic lock.

In a preferred embodiment of the present invention, the lock is provided with at least a lock slot. The operation unit comprises at least a sensor provided on the periphery of the lock slot and connected to the locking unit.

In a preferred embodiment of the present invention, the unlocking unit comprises a light-emitting unit, a switch provided on the surface of one end of the key and connected to the light-emitting unit, a light-guiding element configured to correspond to the light-emitting unit.

In a preferred embodiment of the present invention, the unlocking unit comprises a light-emitting unit, a switch provided on the surface of one end of the key and connected to the light-emitting unit, a light-guiding element configured to correspond to the light-emitting unit, a plurality of encoding light-emitting elements provided on the other end of the key, and an encoding reflective plate provided between the light-guiding element and the encoding light-guiding elements.

In a preferred embodiment of the present invention, the light-emitting unit comprises light-emitting element and a battery electrically connected to the light-emitting element. The light-emitting element can be light-emitting diodes (LED), LASER (LS) or LASER diodes (LD). The battery can be a thin film solar battery or a lithium battery.

In a preferred embodiment of the present invention, the light-guiding element and the encoding light-guiding element can be optical fibers or other materials that can transmit light.

In a preferred embodiment of the present invention, the unlocking unit comprises a light-reversing wavelength multiplexer provided at one end of the key, an inward light-guiding element and an outward light-guiding element provided at the other end of the key and correspond to the light-reversing wavelength multiplexer.

In a preferred embodiment of the present invention, the inward light-guiding element and the outward light-guiding element can be optical fibers or other materials that can transmit light.

In a preferred embodiment of the present invention, a reinforcing portion is provided between the inward light-guiding element and the outward light-guiding element, thereby reinforcing the physical properties between these two light-guiding elements.

In a preferred embodiment of the present invention, the light-reversing wavelength multiplexer is configured as a prism for reflecting an incident light to the outside.

In a preferred embodiment of the present invention, the operation unit comprises a light-emitting unit provided in the lock slot and a sensor connected to the locking unit.

In a preferred embodiment of the present invention, the light-emitting unit comprises a light-emitting element and a battery electrically connected to the light-emitting element. The light-emitting element can be light-emitting diodes (LED), LASER (LS) or LASER diodes (LD). The battery can be a thin film solar battery or a lithium battery.

### BRIEF DESCRIPTION OF THE DRAWINGS

FIG. 1 is a schematic view showing the first and second embodiments of the present invention; and

FIG. 2 is a schematic view showing the third embodiment of the present invention.

### DETAILED DESCRIPTION OF THE PREFERRED EMBODIMENTS

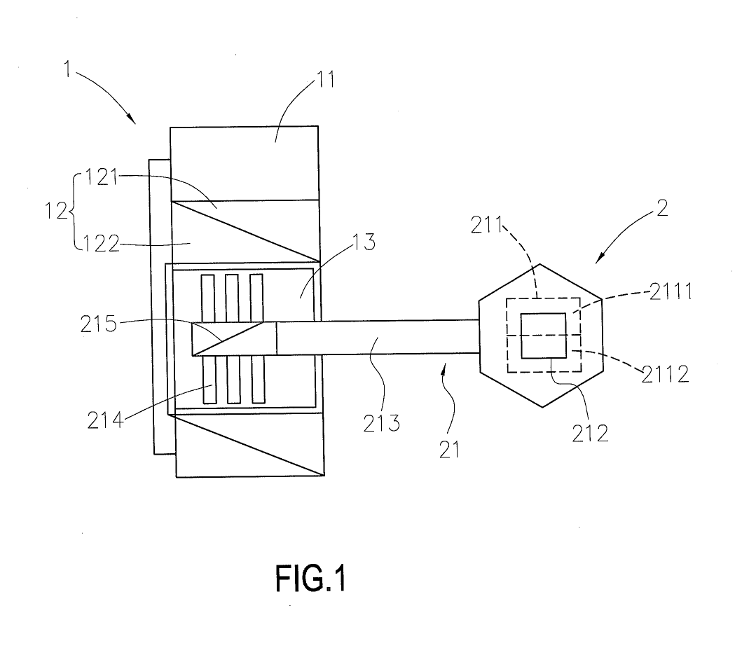

Please refer to FIG. 1, which is a schematic view showing the first and second embodiments of the present invention. As shown in this figure, the present invention provides an optical device, which at least comprises a lock 1 and a key 2.

The lock 1 comprises a locking unit 11 and an operation unit 12 connected to the locking unit 11. The locking unit 11 can be a mechanical lock or an electromagnetic lock. The lock 1 is at least provided with a lock slot 13. The operation unit 12 comprises a least a sensor 121 provided on the periphery of the lock slot 13 and connected to the locking unit 11, and a reflective plate 122 provided to correspond to the sensor 121. The reflective plate 122 is configured to change the travelling path of light.

The key 2 is configured to correspond to the lock 1 and at least comprises an unlocking unit 21. The unlocking unit 21 comprises a light-emitting unit 211 provided at one end of the key 2, a switch 212 provided on one end surface of the key 2 and connected to the light-emitting unit 211, at least a light-guiding element 213 configured to correspond to the light-emitting unit 211, a plurality of encoding light-guiding elements 214 provided at the other end of the key 2, and an encoding reflective plate 215 provided between the light-guiding element 213 and the encoding light-guiding elements 214. The light-emitting unit 211 comprises a light-emitting element 2111 and a battery 2112 electrically connected to the light-emitting element 2111. The light-emitting element 2111 can be light-emitting diodes (LED), LASER (LS) or LASER diodes (LD). The battery 2112 can be a thin film solar battery or a lithium battery. The light-guiding element 213 and the encoding light-guiding element 214 can be optical fibers or other materials that can transmit light. The structure of the light-guiding element 213 is not limited to a tubular body, and can be configured to have any suitable shape. By the above-mentioned constituents, the optical device of the present invention can be obtained.

In use, the key 2 is inserted into the lock slot 13 of the lock 1. After the switch 212 is pressed, the battery 2112 of the light-emitting unit 211 provides necessary electricity for the light-emitting element 2111. The light generated by the light-emitting element 2111 is guided by the light-guiding element 213 to the encoding reflective plate 215 and converted into light of different wavelength by the encoding light-guiding elements 214. At this time, the operation unit 12 of the lock 1 receives the light via the cooperation of the sensor 121 and the reflective plate 122. After the sensor 121 detects and recognizes the thus-generated light, the operation unit 12 is activated to unlock the locking unit 11, thereby completing an unlocking action.

Alternatively, the key 2 can be not physically (i.e. virtually) inserted into the lock slot 13. For example, the sensor 121 provided in the lock slot 13 can detect the refraction and reflection of light or different brightness of light to unlock the locking unit 11. Further, the sensor 121 can be configured to involve various combinations of different secret codes indicating different refraction or reflection rates of light respectively (such combinations can be configured as a switch involving 0/1 codes), thereby acting as an unlocking mechanism for the locking unit 11.

In the first embodiment, the operation unit 12 of the lock 1 can only comprises a sensor 121 provided on the periphery of the lock slot 13 and connected to the locking unit 11 without the reflective plate 122. Also, the light generated by the light-emitting element 2111 can be guided by the light-guiding element 213 to the sensor 121 directly without the encoding light-guiding elements 214 and the encoding reflective plate 215 to unlock the locking unit 11. The way of unlocking the locking unit 11 can be achieved by turning the key 2 to mechanically unlock the locking unit 11 or electromagnetically unlock the locking unit 11. In such a modified embodiment, the light generated by the encoding light-guiding elements 214 of the key 2 is directly introduced into the sensor 121, so that the light is detected and recognized by the sensor 121 to unlock the lock 1.

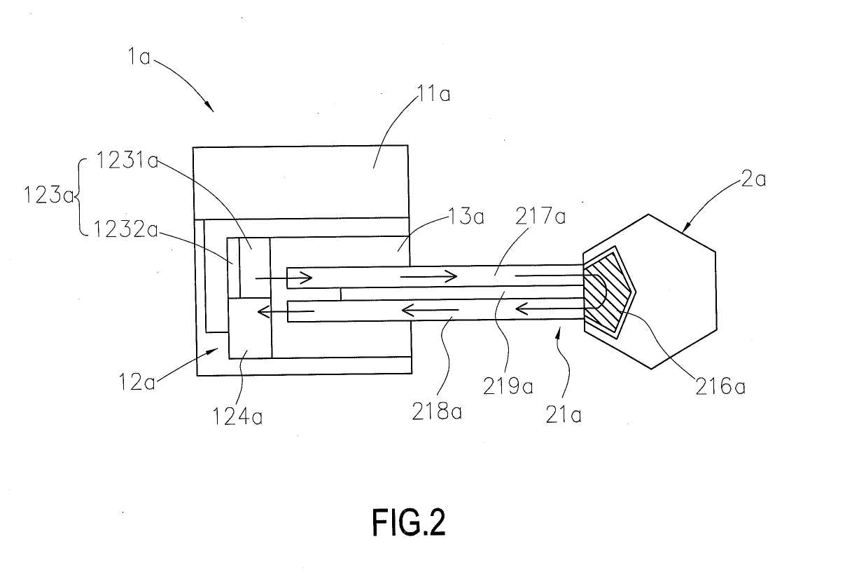

Please refer to FIG. 2, which is a schematic view showing the third embodiment of the present invention. In addition to the structure of the first and second embodiments, the present invention can be configured as the third embodiment shown in FIG. 2. The difference between the third embodiment and the first and second embodiments lies in that: the locking unit 11a is at least provided with a lock slot 13a. The operation unit 12a comprises at least a light-emitting unit 123a provided in the lock slot 13a, and at least a sensor 124a connected to the locking unit 11a. The light-emitting unit 123a comprises a light-emitting element 1231a and a battery 1232a electrically connected to the light-emitting element 1231a. The light-emitting element 1231a can be light-emitting diodes (LED), LASER (LS) or LASER diodes (LD). The battery 1232a can be a thin film solar battery or a lithium battery. The unlocking unit 21a comprises a light-reversing wavelength multiplexer 216a provided at one end of the key 2a, at least an inward light-guiding element 217a and at least an outward light-guiding element 218a provided at the other end of the key and correspond to the light-reversing wavelength multiplexer 216a. The inward light-guiding element 217a and the outward light-guiding element 218a can be optical fibers or other materials that can transmit light. A reinforcing portion 219a is provided between the inward light-emitting element 217a and the outward light-emitting element 218a. More specifically, the light-reversing wavelength multiplexer 216a can be a prism for reversing incident light to the outside. Further, the light-reversing wavelength multiplexer 216a, the outward light-guiding element 218a or the inward light-guiding element 217a can have encoding functions.

In use, the inward light-guiding element 217a, the outward light-guiding element 218a, and the reinforcing portion 219a are simultaneously inserted into the lock slot 13a of the lock 1a, so that the battery 1232a of the light-emitting unit 123a of the operation unit 12a can provide necessary electricity for the light-emitting element 1231a. Then, the light generated by the light-emitting element 1231a is transmitted to the inward light-guiding element 217a and guided into the light-reversing wavelength multiplexer 216a. After being optically processed by the light-reversing wavelength multiplexer 216a, the thus-generated light is transmitted from the outward light-guiding element 218a to the sensor 124a of the operation unit 12a. At this time, the sensor 124a receives the light. After the sensor 124a detects and recognizes the light, the operation unit 12a is activated to unlock the locking unit 11a, thereby completing the unlocking action.

According to the above, the optical device of the present invention really overcomes the problems in prior art, so that light can be transmitted between a lock and a key of the optical device without being intercepted and decoded easily. Thus, the optical device of the present invention cannot be reproduced by others. Further, the structure of the optical device of the present invention does not decay easily. Therefore, the present invention has an excellent anti-theft effect and a reduced production cost, which really demonstrates practicability, industrial applicability, novelty and inventive steps and thus conforms to the requirements for an invention patent.

Although the present invention has been described with reference to the foregoing preferred embodiments, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. An optical device, including:
a lock, comprising at least a lock slot, at least a locking unit for controlling the locked or unlocked state of the lock, and at least an operation unit connected to the locking unit, the operation unit comprising at least a sensor provided on the periphery of the lock slot and connected to the locking unit; and
a key, configured to correspond to the lock and inserted into the lock slot of the lock, the key comprising an unlocking unit, the unlocking unit having a light-emitting unit provided at one end of the key, the light-emitting unit being connected to a switch for controlling the ON/OFF state of the light-emitting unit, at least a light-guiding element being connected or embedded to the rest structure of the key for transmitting the light to the sensor.

2. The optical device according to claim 1, wherein a plurality of encoding light-guiding elements are connected with the light-guiding element being provided with a reflective plate for changing or directing the travelling path of light and guiding the light transmitted by the light-guiding element to the sensor through the encoding light-guiding elements.

3. The optical device according to claim 1, wherein another reflective plate is provided in the lock and corresponds to the sensor, thereby reflecting the light transmitted by the light-guiding element to the sensor.

4. The optical device according to claim 1, wherein the light-emitting unit comprises light-emitting element and a battery electrically connected to the light-emitting element, and the battery is electrically connected to the switch.

5. The optical device according to claim 4, wherein the light-emitting element can be light-emitting diodes (LED), LASER (LS) or LASER diodes (LD) whose wavelength can be detected by the sensor, and the battery can be a thin film solar battery or a lithium battery.

6. The optical device according to claim 1, wherein the locking unit can be a mechanical lock or an electromagnetic lock.

7. The optical device according to claim 1, wherein the light-guiding element has an encoding function.

8. The optical device according to claim 1, wherein the light-guiding element and the encoding light-guiding elements can be optical fibers or other materials that can transmit light.

9. The optical device according to claim 2, wherein the light-guiding element and the encoding light-guiding elements can be optical fibers or other materials that can transmit light.

10. An optical device, including:
a lock, comprising at least a lock slot, at least a locking unit for controlling a locked or unlocked state of the lock, at least an operation unit connected to the locking unit, the operation unit comprising at least a sensor connected to the locking unit, and at least a light-emitting unit provided in the lock slot; and
a key, configured to correspond to the lock and inserted into the lock slot of the lock, the key comprising an unlocking unit, the unlocking unit having a light-reversing wavelength multiplexer provided at one end of the key, the light-reversing wavelength multiplexer being connected to at least an inward light-guiding element for receiving the light generated by the light-emitting unit and at least an outward light-guiding element corresponding to the sensor, the light-reversing wavelength multiplexer, the inward light-guiding element and the outward light-guiding element together form a light path.

11. The optical device according to claim 9, wherein the light-emitting unit comprises a light-emitting element and a battery electrically connected to the light-emitting element.

12. The optical device according to claim 10, wherein the light-emitting element can be light-emitting diodes (LED) and LASER (LS) or LASER diodes (LD), and the battery can be a thin film solar battery or a lithium battery.

13. The optical device according to claim 9, wherein the inward light-guiding element and the outward light-guiding element can be optical fibers or other materials that can transmit light.

14. The optical device according to claim 9, wherein the light-reversing wavelength multiplexer is configured as a prism for reversing light.

15. The optical device according to claim 9, wherein a reinforcing portion is provided between the inward light-guiding element and the outward light-guiding element.

16. The optical device according to claim 9, wherein the light-reversing wavelength multiplexer, the inward light-guiding element, and the outward light-guiding element have encoding functions.
